(19) United States
(12) Patent Application Publication
(10) Pub. No.: US 2013/0295258 A1
(43) Pub. Date: Nov. 7, 2013

(54) DEVICE FOR HOLDING A NUMBER OF FISH TO BE PREPARED AND FISH PREPARATION METHOD

(71) Applicant: Konrad GLAS, Possenhofen (DE)

(72) Inventor: Konrad GLAS, Possenhofen (DE)

(21) Appl. No.: 13/941,173

(22) Filed: Jul. 12, 2013

Related U.S. Application Data
(63) Continuation of application No. PCT/EP2012/000060, filed on Jan. 9, 2011.

(30) Foreign Application Priority Data
Jan. 14, 2011 (DE) 102011008647.1

(51) Int. Cl. A47J 43/18

(52) U.S. Cl. CPC A47J 43/18
USPC 426/523; 99/419

(57) ABSTRACT

A device for holding a number of fish to be prepared in an orientation in which the stomach side of the fish is directed upwards, the device having a basic structure which can be positioned on a horizontal surface or can be suspended on a holding structure or arranged on the device, and that the device has, for each fish to be held, a plurality of spikes which are oriented parallel to one another and project by way of a free end from the basic structure such that a fish, the side flanks of which have been skewered via the free ends of the spikes assigned to it, can be held on the device with its stomach side; directed upwards and in the process such that only the spikes assigned to the fish are in contact with the fish.

### CROSS REFERENCE TO RELATED APPLICATIONS

This is a continuation of International Application PCT/EP2012/000060, filed on Jan. 9, 2012, which claims priority to DE Application 10 2011 008 647.1, filed Jan. 14, 2011, the contents of each of which are incorporated by reference herein.

### BACKGROUND

The present invention pertains to a device for holding a number of fish to be prepared in an orientation in which the stomach side of the fish is directed upwards, whereby the device has a basic structure which can be positioned on a horizontal surface and/or suspended from a holding structure by means of a suspension provision arranged on the device, as well as a fish preparation method.

Such a device is already known from WO 2009/065624. The device displayed there, which has a cage-like structure for the purpose of resting the device on a grilling appliance or on another, mainly even storage surface, features a number of double-spiked holding elements which traverse the length of the device and on which the fish to be prepared is skewered from above with its stomach side open. Each double-spiked holding element has a cross support on which the fish spine rests and which runs underneath the element's pointed ends. Furthermore, the device contains a number of separate cross-skewers which are driven through (i.e. from one side flank of the fish to the other) and above the spine of the fish skewered on the respective holding elements. In this position, the cross-skewers can be held in designated guides of the cage-like structure. The cage-like structure is thereby designed in a way that allows it to be placed on the surface in various orientations without the fish or numerous fish arranged next to each other in contact with the surface, and whereby an orientation in which the fish lie with their stomach facing upwards is permissible. This orientation of the fish has the advantage that during the preparation process (e.g. on a grill or in a baking oven), the fluid collecting in the open abdominal cavity of the fish cannot leak or drip out, which results in a high-quality preparation outcome. Another advantage is that each fish on this device is in contact exclusively with the spikes skewering it and with the double-spiked holding elements, whereby damage to the fish skin is mostly avoided.

The device described in WO 2009/065624, however, has the disadvantage of having a relatively complex construction, thereby being comparatively expensive to manufacture.

The DE 9111045 U1 displays a grilling appliance with a lateral, retractable tray to hold the grilled fare. The tray is either collapsible or has synclinal, claw or clamp shaped brackets vertically positioned above one another, which are located on one side of the grill tray. When preparing fish, it is recommended to use the collapsible grill tray. A space-saving accommodation of more than one fish, especially if these are prepared in a separate preparation device, as intended here, is not possible with this device.

### SUMMARY

In view of the above, the purpose of the present invention is to manufacture a novel, preferably simple and space-saving fish holding device, which allows the skewering of a number of fish facing stomach side-up in order to achieve the best possible preparation result. A further purpose is to supply a corresponding method of fish preparation with which an optimal preparation result can be achieved with a preferably small amount of effort.

The aforesaid task is solved by the afore-described, invented device in that the device features a number of parallel positioned spikes for each fish to be skewered. These spikes project from the basic structure with a free spike in such a way that a fish skewered through its side flanks via the respective free spikes can be held by the device stomach side-up and is thus exclusively in contact with the spikes allocated to the particular fish, and that one grouping of spikes holds the first fish and a second grouping of spikes holds a second, both projecting from the sides of the basic structure, facing away from each other.

Within the framework of the present invention, the device is thus meant to hold several fish that are to be prepared in a supine position, i.e. stomach side facing upwards. For this purpose, the invented fish holding device provides each fish, in an especially simple manner of implementation, with a number of parallel running spikes, each having a free end, which project in proper relation to and from the basic structure so that the fish to be prepared can be skewered especially easily onto the various, assigned spikes.

Thus, the spikes on the device provided for this purpose should preferably be segments of stainless steel wire (with a diameter of e.g. 2, 3, 4 or 5 mm) which are pointed at their free end in order to skewer the fish through its side flanks in the simplest manner on the designated spikes.

The pointed ends of the spikes assigned to each fish should preferably all lay on a straight line which runs vertically to the extension of the spikes and which can lean either (slightly) towards the horizontal or can run parallel thereto. In the last scenario, all spikes assigned to a fish are favorably positioned at approximately the same height on the basic structure. In this way, the direct axis of the skewered fish lying stomach side-up is roughly in a horizontal position.

It is especially advantageous that a fish can be skewered on the designated spikes of the invented device in such a manner that its spine—in the described mounting position in which the stomach side of the fish points upward—is propped up by the spikes holding the fish.

When preparing fish in e.g. a baking oven, a smoke oven, a steam convection oven, a steam cooker, a combi steamer, on a grill (preferably with a lid), in a smoker, fryer, stock pot or any other preparation device, its entire length is at all times supported by a number of spikes piercing the fish below its spine. In this way, the invented device securely holds the fish at all times.

Because during preparation, the invented device allows for the fish to only be held by and be in contact with the spikes piercing it, an optically appealing preparation result can be achieved since possible damage to its skin is reduced to a minimum. The expected support is thus achieved by simple means and the fact that the fish is pointing stomach side-up prevents leakage of the fluid collecting in the fish abdominal cavity.

The spikes assigned to each fish are preferably arranged at equal intervals one below the other so that the fish can be held by the spikes at equal intervals via its entire length and underneath its spine. Preferably at least two and even better, three or four spikes, should be allocated to hold each fish. It is possible to allocate an even larger number of spikes to each fish that is to be held by the invented device.

The invented device is designed to hold a number of fish. For this purpose, an appropriate number of spikes to hold each fish are constructed on the device so that each fish can be held by the designated spikes on the device in the afore-described manner.

The present invention hereby provides that a first grouping of spikes hold the first fish and a second grouping of spikes hold the second fish in the invented manner, in such a fashion that the spikes project from the basic structure on opposite sides, facing away from one another. This allows for an especially compact and space-saving configuration of the invented device which should hold at least two fish.

Moreover, the invention provides the advantage that in addition to the first or second grouping of spikes which hold the first and second fish; a further grouping of spikes can be arranged to hold another fish above the first or second grouping of spikes on the same side of the basic structure. In this way, the device can hold several fish, one above the other, in the desired supine position, a concept which especially allows the present invention to be used in steam convection ovens and in circulating air ovens, etc.

Another advantage is that with correct mounting or suspension of the device, the spikes projecting from the basic structure extend horizontally or point from the horizontal diagonally upwards with their free end. This way, the fish is unable to slip off the free ends of the spikes holding it during preparation.

It is also useful, when at the basic structure of the device at least one support structure is removable, whereby the spikes used to skewer the respective fish are firmly attached to, or part of, said support structure. This has the advantage that the spikes and the support structure can both be removed from the basic structure, which allows an easier skewering of a fish to the spikes which are fixed to, and arranged parallel on, the support structure. Subsequently, the support structure including spikes and skewered fish can be reattached to the basic structure, e.g. by suspending it from or mounting it on the appropriate holding element on the basic structure, so that the fish lies in the desired supine position on the device.

The spikes on the device can hereby either be firmly fixed to a support structure that is removable from the basic structure (where applicable, as an integral part of said support structure), or each grouping of spikes intended to hold one fish each, can have its own support structure on which the spikes are attached parallel to one another in accordance with the orientation required by the invention. In the latter case, it is of an advantage when each support structure is constructed the same as all other support structures, so that these are freely exchangeable. The basic structure can then be shaped in a preferably frame-like manner with a suitable mounting device at its base (e.g. a pedestal) and/or a suitable hanging device at its top surface. Various sides of the frame-like structure, which favorably provide a stretched out vertical plane, can feature at least one attached, removable support structure with appropriate spikes projecting sideways from the support structure.

Such a support structure favorably embraces two parallel-running braces, which, when the support structure is attached appropriately to the basic structure, are vertically positioned to each other, whereby the two braces are connected by a number of crossbeams and disposed in a spaced relationship. Each spike is hereby formed by a bent limb of one of the crossbeams; each pointed at is free end. When the braces and crossbeams are formed from stainless steel wire, these can be easily welded together. For the purpose of attaching the support structure to the basic structure, the upper of the two longitudinal braces can be favorably suspended from suitable holding elements at the basic structure—preferably at the same height. An especially useful configuration of the present invention provides that the device is designed to hold (overall, i.e. at least) four fish, whereby each fish is assigned a separate support structure and the grouping of spikes attached thereto, and whereby (at least) two support structures can be vertically attached, one above the other, on each side of the basic structure, facing away from one another.

It is further preferable to ensure that the various spike groupings for holding each of the fish be arranged at the same height so that the longitudinal axis of the fish fastened appropriately thereupon is positioned horizontally.

The support structure, the spikes and/or the basic body can be favorably manufactured from rust-free (stainless) steel, especially from an appropriately bent steel wire, whereby the basic structure can be suitably made from a laser-cut, single sheet-steel blank. This is bent to a circular frame with vertical limbs that have at least one support structure suspended from them, in the before-described manner, and with the appropriate holding elements.

The invented device for the preparation of fish performed using a device such as described above, is characterized by the following steps:
A) Skewering of (at least) one fish on the free ends of the various, parallel positioned spikes, whereby the spikes pierce through the side flanks of the fish in such a manner that each spike pierces through and underneath the spine of the fish lying in supine position.
B) Preparation of (at least) one fish while it is being held in supine position by the device and whereby the fish is exclusively in contact with the spikes piercing through it.

With respect to the current advantages and any advantageous improvements of the invented device, all previously explained aspects related to the invented device apply, so that replication can be avoided. The preparation of at least one fish occurs in that the invented device, along with at least one fish held thereupon, is mounted on or suspended from a suitable preparation device, and that the at least one fish is subsequently exposed to the physical environment utilized for its preparation (e.g. heat, steam or smoke, etc.).

In step (A) of the invented device, it should be ensured that the fish is skewered in such a manner that, with proper mounting/suspension of the device, each spike pierces the supine lying fish, underneath its spine, so that the spikes support the fish in the afore-described position underneath its spine.

### BRIEF DESCRIPTION OF THE DRAWINGS

As follows, an example of how the invention is used is described in further detail as per the drawing. Shown are:

FIG. 1 an example of how the invented device is used in perspective view;

FIG. 2 the device from FIG. 1 in lateral view;

FIG. 3 the device from FIG. 1 in a lateral view offset by 90°; and

FIG. 4 the device from FIG. 1 in top view.

### DETAILED DESCRIPTION

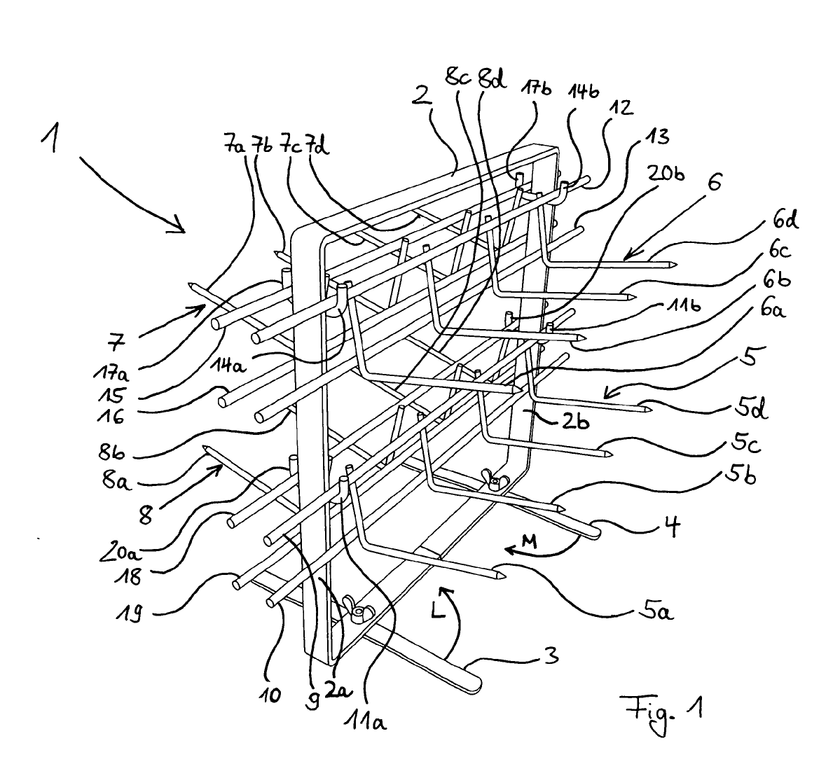

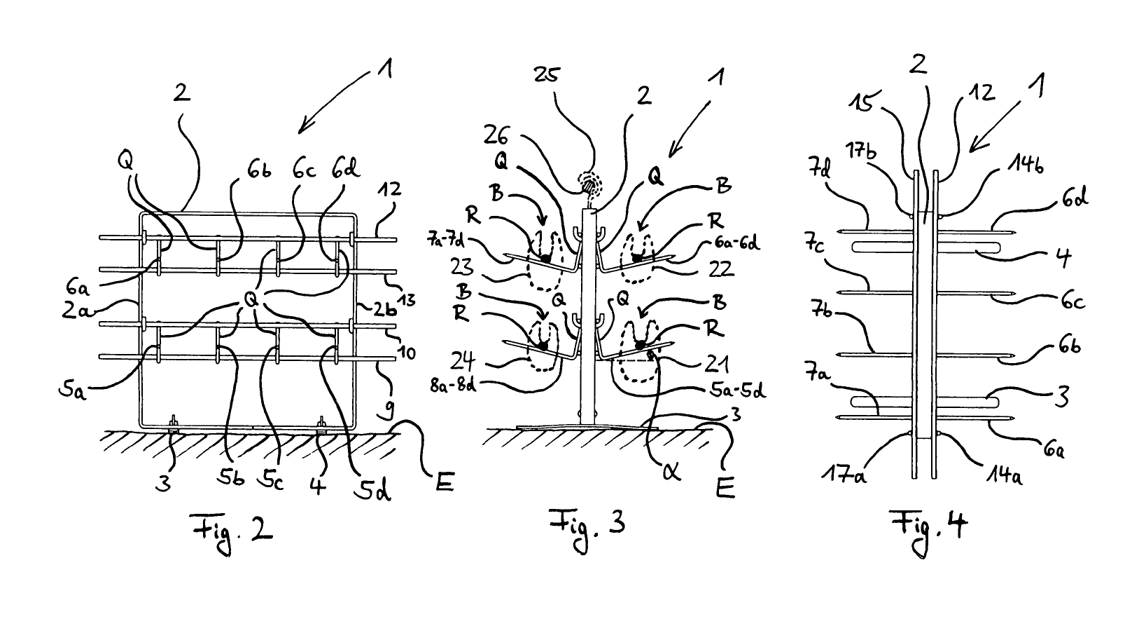

Device 1 shown in FIG. 1-4 serves to (simultaneously) hold a total of four fish 21, 22, 23, 24 that are to be prepared (see dotted depiction of the fish cross-section in FIG. 3) lying in a supine position B. For this purpose, device 1 has a frame-like basic structure 2 which can be set up on a largely horizontal, and even, surface E (see FIGS. 2 and 3) by means of two support feet 3, 4. The support feet 3, 4, which project laterally from the basic structure in order to secure a firm footing of device 1 holding at least one fish, can be swiveled under the basic structure as per arrows L, M. In this way, the device can be stored in a space-saving manner and e.g. be washed in a dishwasher.

Device 1 has a total of four groupings 5, 6, 7, 8, of four spikes each 5a-5d, 6a-6d, 7a-7d, 8a-8d, which are positioned (in groups) parallel to one another, and which project laterally from the basic structure with a free, pointed tip. On each side of the frame-like basic structure 2, you see two groupings 5, 6, i.e. 7, 8, of four spikes each, whereby the groupings arranged on the same side of the basic structure 2 are each positioned vertically over one another, resulting in an overall space-saving design.

In this way, the spikes 5a-5d, 6a-6d, 7a-7d, 8a-8d occupy an inclined position at an angle of inclination a to the horizontal, in which each free end points slightly diagonally upwards. This prevents the fish 21, 22, 23, 24, which is skewered on the respective grouping 5, 6, 7, 8 of the spikes 5a-5d, 6a-6d, 7a-7d, 8a-8d that are positioned parallel under one another, from sliding off the free ends of the spikes 5a-5d, 6a-6d, 7a-7d, 8a-8d. Fish 21, 22, 23, 24 are (or, as per the configuration of device 1, can be) each skewered onto one of the groupings 5, 6, 7, 8, of the grouped spikes 5a-5d, 6a-6d, 7a-7d, 8a-8d, each arranged at the same height of device 1, in such a manner that the spikes pierce each respective fish 21-24, which has its stomach side B pointing upwards, right underneath the spine R (see FIG. 3). The longitudinal axis, which runs in concurrence with spine R (in FIG. 3, positioned perpendicular to the drawing plane), of fish 21-24, mainly takes a horizontal position. For the purpose of preparing the fish 21-24, device 1 including the fish 21-24 is placed in a suitable preparation device.

Spikes 5a-5d, 6a-6d, 7a-7d, 8a-8d are not, though it would be possible, attached directly to (or a part of) basic structure 2 of device 1. Instead, they are attached to (or part of) a support structure which is formed respectively from two parallel running braces 9/10, 12/13, 15/16, 18/19. The support structures are hereby separately attached to basic structure 2 in a removable manner. For this purpose, two holding elements 11a, 11b, 14a, 14b, 17a, 17b, 20a, 20b, are provided for each support structure at the vertical limbs 2a, 2b of basic structure 2, from which each upper brace 9, 12, 15, 18 of the respective support structure is suspended. In the arrangement of the present example, gravity causes the respective, lower brace 10, 13, 16, 19, of the respective support structure to rest at the two vertical limbs 2a, 2b, of the basic structure 2. Hereby, the relative position of the attached support structure, attached to basic structure 2 (per suspension) as per the instructions, and thus also the relative position of the spikes 5a-5d, 6a-6d, 7a-7d, 8a-8d, projects properly from the basic structure 2 with the tips free. Each spike 5a-5d, 6a-6d, 7a-7d, 8a-8d, constitutes a bent limb of a crossbeam Q (see FIG. 3), which connects the two braces 9/10, 12/13, 15/16, 18/19, of each support structure. The spikes 5a-5d, 6a-6d, 7a-7d, 8a-8d, are fused with the two braces 9/10, 12/13, 15/16, 18/19, of the respective support structure near the respective crossbeam Q.

The dotted lines in FIG. 3 (not shown in the other diagrams) show an additional, optional suspension device 25 (one or more hooks spaced lengthwise) at the top of the frame-like basic structure 2, so that device 1 can be suspended from e.g. a suitable holding structure (e.g. horizontal bar 26) in a e.g. smoker oven, etc., in case no suitable standing surface E is available onto which to place device 1.

I claim:

1. A device for holding a number of fish to be prepared in a position in which the stomach side each of the fish points upwards, whereby the device has a basic structure which can be suspended from a support structure and set up on a horizontal surface or suspended by a suspension provision located on the device, the device further comprising multiple spikes for each fish to be held by the device that are in a parallel position to one another, the spikes projecting from the basic structure with a free end in such a way that each of the fish, which is skewered in supine position via the free ends through its side flanks, is thus exclusively in contact with the spikes assigned to each fish, and such that a first grouping of spikes project out in order to hold a first fish of the number of fish, and a second grouping of spikes to hold a second fish of the number of fish at the basic structure, on the two sides facing away from each other.

2. The device of claim 1, wherein in addition to the first and second groupings of spikes for the purpose of holding a first or second fish, at least one further grouping of spikes for the purpose of holding an additional fish is provided, which are located on the same side of the basic structure, though above the first or second grouping of spikes.

3. The device of claim 1, wherein with proper mounting, such as a suspension of the device, the various spikes extend horizontally from the basic structure or point diagonally (at an angle a) upwards in relation to the horizontal.

4. The device of claim 1, wherein at the basic structure of the device, at least one support structure is attached in a removable fashion, whereby the spikes to be used to skewer the respective fish are fixedly attached to, or part of, the same support structure.

5. The device of claim 4, wherein the at least one support structure has two parallel running braces, which with proper attachment of the support structure to the basic structure, are vertically positioned relative to one another, whereby the two braces are connected by a number of crossbeams, spaced apart from each other, whereby each spike is formed by a bent limb pointed at its tip, located on one of the crossbeams.

6. The device of claim 4, wherein the device is designed to hold four fish, and whereby each fish is assigned a separate support structure and the grouping of spikes attached thereto, and whereby two support structures each are vertically attachable one above the other, on the sides of the basic structure, facing away from one another.

7. The device of claim 1, wherein the various spikes for holding the respective fish are each arranged at the same height so that the longitudinal axis of the fish properly skewered to it is horizontally positioned.

8. The device of claim 1, wherein each fish to be held by the device is assigned three or four spikes.

9. The device of claim 1, wherein the support structure, the spikes and the base body are manufactured of stainless steel, specifically of a suitably bent steel wire.

10. A method for the preparation of a fish using the device of claim 1, comprising:
skewering a fish onto the free ends of a number of parallel running spikes through the side flanks of the fish in such a way that each spike pierces the fish held in supine position underneath its spine; and preparing the fish while it is held on the device in a supine position, whereby the fish is exclusively in contact with the spikes piercing through it.
